(19) United States
(12) Patent Application Publication
(10) Pub. No.: US 2026/0268071 A1
(43) Pub. Date: Sep. 10, 2026

(54) SYSTEM AND METHOD FOR USE OF SPREADSHEETS INTEGRATED WITH WEB SERVICES INCLUDING SUPPORT FOR ROW STATUS CUSTOM ACTIONS

(71) Applicant: ORACLE INTERNATIONAL CORPORATION, Redwood Shores, CA (US)

(72) Inventors: Edmund Alex Davis, San Mateo, CA (US); Kelsey Von Tish, Salem, MA (US)

(21) Appl. No.: 19/192,842

(22) Filed: Apr. 29, 2025

Related U.S. Application Data
(60) Provisional application No. 63/767,981, filed on Mar. 6, 2025.

(51) Int. Cl. G06F 40/18

(52) U.S. Cl. CPC G06F 40/18

(57) ABSTRACT

In accordance with various embodiments, described herein is a system and method for use of spreadsheets integrated with web services, including support for row status custom actions. The system provides a process for combining or aggregating information from multiple endpoints such as web services or other sources, within a spreadsheet interface, for example to enable viewing of errors, validation failures, policy warnings, recommendations, or other information; fetching and displaying additional information relevant to existing business data; or providing access to additional services, for example generative artificial intelligence services, to incorporate recommendations or information provided by those services. As the user interacts with the spreadsheet and with particular rows of data or particular cells, the system can automatically communicate with, receive responses, and combine or aggregate related information from one or more web services or other sources, within the spreadsheet interface, and display a row status associated with the data.

### CLAIM OF PRIORITY AND CROSS-REFERENCE TO RELATED APPLICATIONS

The present application claims the benefit of priority to U.S. Provisional patent application titled “SYSTEM AND METHOD FOR USE OF SPREADSHEETS INTEGRATED WITH WEB SERVICES INCLUDING SUPPORT FOR ROW STATUS CUSTOM ACTIONS”, Application No. 63/767,981, filed Mar. 6, 2025; and is related to U.S. patent application titled “EDITABLE TABLE IN A SPREADSHEET INTEGRATED WITH A WEB SERVICE”, application Ser. No. 16/145,029, filed Sep. 27, 2018, and subsequently issued as U.S. Pat. No. 11,138,371 on Oct. 5, 2021; U.S. patent application titled “EDITABLE TABLE IN A SPREADSHEET INTEGRATED WITH A WEB SERVICE”, application Ser. No. 17/387,411, filed Jul. 28, 2021, and subsequently issued as U.S. Pat. No. 11,443,110 on Sep. 13, 2022; U.S. patent application titled “CUSTOM ACTION INVOCATION IN A SPEADSHEET INTEGRATED WITH WEB SERVICES”, application Ser. No. 16/917,384, filed Jun. 30, 2020, and subsequently issued as U.S. Pat. No. 11,848,976 on Dec. 19, 2023; and U.S. patent application titled “INTERACTIVE DATA ENTRY VALIDATION AND PROBLEM CORRECTION IN A TABLE COMPONENT IN A SPREADSHEET DRIVEN BY A WEB SERVICE”, application Ser. No. 17/364,720, filed Jun. 30, 2021, and subsequently issued as U.S. Pat. No. 11,443,109 on Sep. 13, 2022; each of which above patent applications and patents, together with the contents thereof, are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to software application development, and are particularly directed to a system and method for use of spreadsheets integrated with web services, including support for row status custom actions.

### BACKGROUND

Software-based spreadsheets are a popular tool by which business users typically can access, update, and analyze their business data. To allow this, some environments allow the use of a spreadsheet to retrieve or update enterprise information via a web service.

However, business data-related information often resides in multiple locations. For example, a particular web service may provide rows of business data for viewing and editing, while the validation or error information associated with that business data may be stored in a different location, or provided by a different web service accessible via a separate interface.

Other business-related information, such as recommendations, may necessitate the use of yet another source of information or interface. While business users may want to manage their data in a familiar spreadsheet format, present systems do not integrate the information from various sources in a coherent fashion.

### SUMMARY

In accordance with various embodiments, described herein is a system and method for use of spreadsheets integrated with web services, including support for row status custom actions.

The system provides a process for combining or aggregating information from multiple endpoints such as web services or other sources, within a spreadsheet interface, for example to enable viewing of errors, validation failures, policy warnings, recommendations, or other information; fetching and displaying additional information relevant to existing business data; or providing access to additional services, for example generative artificial intelligence services, to incorporate recommendations or information provided by those services.

As the user interacts with the spreadsheet and with particular rows of data or particular cells, the system can automatically communicate with, receive responses, and combine or aggregate related information from one or more web services or other sources, within the spreadsheet interface, and display a row status associated with the data.

### BRIEF DESCRIPTION OF THE DRAWINGS

FIG. 1 illustrates a system for use of spreadsheets integrated with web services, in accordance with an embodiment.

FIG. 2 further illustrates a system for use of spreadsheets integrated with web services, including support for a hierarchical object data model, in accordance with an embodiment.

FIG. 3 further illustrates support for a hierarchical object data model, in accordance with an embodiment.

FIG. 4 illustrates the use of spreadsheets integrated with web services, including support for custom actions, in accordance with an embodiment.

FIG. 5 further illustrates support for custom actions, in accordance with an embodiment.

FIG. 6 illustrates how the system can be used to combine related information from multiple web services or other sources, in accordance with an embodiment.

FIG. 7 further illustrates how the system can be used to combine related information from multiple web services or other sources, in accordance with an embodiment.

FIG. 8 further illustrates how the system can be used to combine related information from multiple web services or other sources, in accordance with an embodiment.

FIG. 9 further illustrates how the system can be used to combine related information from multiple web services or other sources, in accordance with an embodiment.

FIG. 10 further illustrates how the system can be used to combine related information from multiple web services or other sources, in accordance with an embodiment.

FIG. 11 further illustrates how the system can be used to combine related information from multiple web services or other sources, in accordance with an embodiment.

FIG. 12 illustrates an example for combining related information from multiple endpoints such as web services or other sources, within a spreadsheet interface, in accordance with an embodiment.

FIG. 13 further illustrates an example for combining related information from multiple endpoints such as web services or other sources, within a spreadsheet interface, in accordance with an embodiment.

FIG. 14 further illustrates an example for combining related information from multiple endpoints such as web services or other sources, within a spreadsheet interface, in accordance with an embodiment.

FIG. 15 further illustrates an example for combining related information from multiple endpoints such as web services or other sources, within a spreadsheet interface, in accordance with an embodiment.

FIG. 16 illustrates a process for combining related information from multiple endpoints such as web services or other sources, within a spreadsheet interface, in accordance with an embodiment.

### DETAILED DESCRIPTION

Software-based spreadsheets are a popular tool by which business users typically can access, update, and analyze their business data. To allow this, some environments allow the use of a spreadsheet to retrieve or update enterprise information via a web service.

However, business data-related information often resides in multiple locations. For example, a particular web service may provide rows of business data for viewing and editing, while the validation or error information associated with that business data may be stored in a different location, or provided by a different web service accessible via a separate interface.

Other business-related information, such as recommendations, may necessitate the use of yet another source of information or interface. While business users may want to manage their data in a familiar spreadsheet format, present systems do not integrate the information from various sources in a coherent fashion.

In accordance with various embodiments, described herein is a system and method for use of spreadsheets integrated with web services, including support for row status custom actions.

The system provides a process for combining or aggregating information from multiple endpoints such as web services or other sources, within a spreadsheet interface, for example to enable viewing of errors, validation failures, policy warnings, recommendations, or other information; fetching and displaying additional information relevant to existing business data; or providing access to additional services, for example generative artificial intelligence (generative-AI, gen-AI) services, to incorporate recommendations or information provided by those services.

As the user interacts with the spreadsheet and with particular rows of data or particular cells, the system can automatically communicate with, receive responses, and combine or aggregate related information from one or more web services or other sources, within the spreadsheet interface, and display a row status associated with the data.

For the purposes of the present discussion, a server may be any computing resource, such as a computer and/or software that is adapted to provide content, e.g., data and/or functionality, to another computing resource or entity that requests it, i.e., the client. A client may be any computer or system, including software system that is adapted to receive content from another computer or system, called a server. A server system may be any collection of one or more servers and accompanying computing resources. The terms “client device” and “client” may be employed interchangeably herein, however, depending upon the context in which the term is used, the term client may refer more generally to both client devices and client software.

A computing environment may be any collection of computing resources used to perform one or more tasks involving computer processing. A computer may be any processor in communication with a memory. A computing resource may be any component, mechanism, or capability or quantities thereof of a computing environment, including, but not limited to, processors, memories, software applications, user input devices, and output devices, servers, and so on. Examples of computing resources include data and/or software functionality offered by one or more web services, Application Programming Interfaces (APIs), etc.

An enterprise computing environment may be any computing environment used for a business or organization. An example enterprise computing environment includes various computing resources distributed across a network and may further include private and shared content on Intranet Web servers, databases, files on local hard discs or file servers, email systems, document management systems, portals, and so on.

A given software application may include (but not necessarily) constituent software applications or modules (e.g., services, functions, procedures, computing objects, etc.). Accordingly, the term “software application” may also include networked software applications or integrated groups thereof.

For the purposes of the present discussion, a software system may be any collection of computing resources implementing machine-readable instructions, i.e., computer code. Accordingly, the term “software system” may refer to a software application, and depending upon the context in which the term is used, may further refer to the accompanying computer(s) and associated computing resources used to run the software application.

Depending upon the context in which the term is used, a software system may further include hardware, firmware, and other computing resources enabling running of the software application. Note that certain software systems may include collections of disparate services, which are implemented in particular sequences in accordance with a process template and accompanying logic. Accordingly, the terms “software system,” “system,” and “software application” may be employed interchangeably herein to refer to modules or groups of modules or computing resources used for computer processing.

For the purposes of the present discussion, a web service may be any computer code and associated functionality that is adapted to be called by an application or other service or process whose code is stored in a separate location (e.g., on another computer or memory storage location or device) from the web service. Accordingly, the term “service” as used herein is relatively broad and may include remotely accessible APIs and services characterized by Web Services Description Language (WSDL) interfaces, Simple Object Access Protocol (SOAP), REpresentational State Transfer (REST), YAML (Yet Another Markup Language), and/or other types of interfaces.

Generally, web services, also simply called services herein, provide functionality, e.g., capabilities, that may be reused by different applications, processes, or web services (that may be distributed across a network), which access the functionality via a service interface (e.g., WSDL interface) consistent with a description of the web service. A web services model may represent a loosely coupled integration model for allowing flexible integration of various network-distributed applications or processes.

Embodiments discussed herein generally related to systems and methods for using software (called client-side software herein) running on a desktop computer, mobile device, or other computer system to authenticate with and access data, update, or otherwise use any functionality provided by web services, e.g., REpresentational State Transfer (REST) services or Application Programming Interfaces (APIs).

For the purposes of the present discussion, a custom action may be any software action implemented via code that has been developed or modified for a particular customer. Depending upon the context in which the term is used, the term custom action may refer to the software action or the code that implements the software action.

A software action may be any process or collection of processes or operations implemented via software. Additional examples of processes include updating or editing data in a database, placing a product order, creating an opportunity business object, creating a business contact object, adding a revenue line to a business object, displaying data visualizations or analytics, triggering a sequence of processes, launching an enterprise software application, displaying a dialog box, implementing a step of a process-based software application and so on. The terms “software action” and “action” are employed interchangeably herein.

Certain embodiments discussed herein are particularly useful for enabling use of client-side spreadsheets, such as Microsoft Excel, to provide input (including bulk input and implementing bulk operations) to server-side process-based software applications, thereby launching/driving the process-based software applications.

A spreadsheet may be any software application, such as Microsoft Excel, or other spreadsheet, for facilitating organization and use of data via tables. Depending upon the context in which the term is used, a spreadsheet may also refer to a document produced by the software application, or may refer to a table shown in a UI display screen of the software application. Alternatively, the term worksheet may refer to particular tables or sections of a spreadsheet UI. A workbook may refer to a collection of one or more worksheets.

Although reference may be made to specific types of spreadsheet programs, e.g., Microsoft Excel, it should be apparent that features of the embodiments can be adapted for use with any suitable spreadsheet program.

A process-based software application may be any software application definable by one or more sequences of steps, also called software activities. A sequence of steps (e.g., as may be involved in an approval flow, for instance) of a process-based software application may be called a process flow. Process flows are often modeled and illustrated via swim lanes in a User Interface (UI) display screen. Process-based applications are often implemented via composite applications that may leverage different web services for different process steps.

Software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

For clarity, certain well-known components, such as the Internet, hard drives, processors, power supplies, routers, Internet Service Providers (ISPs), workflow orchestrators, process schedulers, identity management clouds, process clouds, certificate authorities, business process management systems, database management systems, middleware, and so on, are not necessarily explicitly called out in the figures. However, those skilled in the art with access to the present teachings will know which components to implement and how to implement them to meet the needs of a given implementation.

Spreadsheet Interfaces Integrated with Web Services

In accordance with an embodiment, a client device can interrogate one or more web services to obtain web service metadata that determines one or more capabilities of those web services. This metadata can be used to automatically configure an editable table component in a spreadsheet. The table component can then be used to retrieve data, edit that data in a spreadsheet, and upload changes back to a web service, or provide validations, recommendations, or other functionalities.

In accordance with various embodiments, the system can include or utilize some or all of the following features:
Integrated Workbook—a software application document that contains metadata that the software extension or add-in component can use to interact with a web service or integration environment, including a layout metadata that defines one or more graphical user interface layouts associated with the workbook. For example, in accordance with an embodiment, a workbook can be provided as a spreadsheet-type document.
Worksheet—a component of a workbook. For example, in accordance with an embodiment, a workbook can be provided as a spreadsheet-type document, and can include one or more worksheet tabs, each having one or more spreadsheets.
Business Object—a web service or other type of service or object, that can be provided within an integration environment and allows operations (e.g., GET, POST, PATCH, or DELETE operations) on a particular resource or object type. For example, in accordance with an embodiment, an expense reports object can be provided that allows operations to create or edit expense reports.
Layout—a binding of one or more business objects to a worksheet, as defined by a workbook metadata, for purposes of allowing operations on the business object. For example, in accordance with an embodiment, a spreadsheet-type document can be associated with a table layout that operates as a binding that allows editing of invoices via a tabular invoice worksheet and an associated web service.

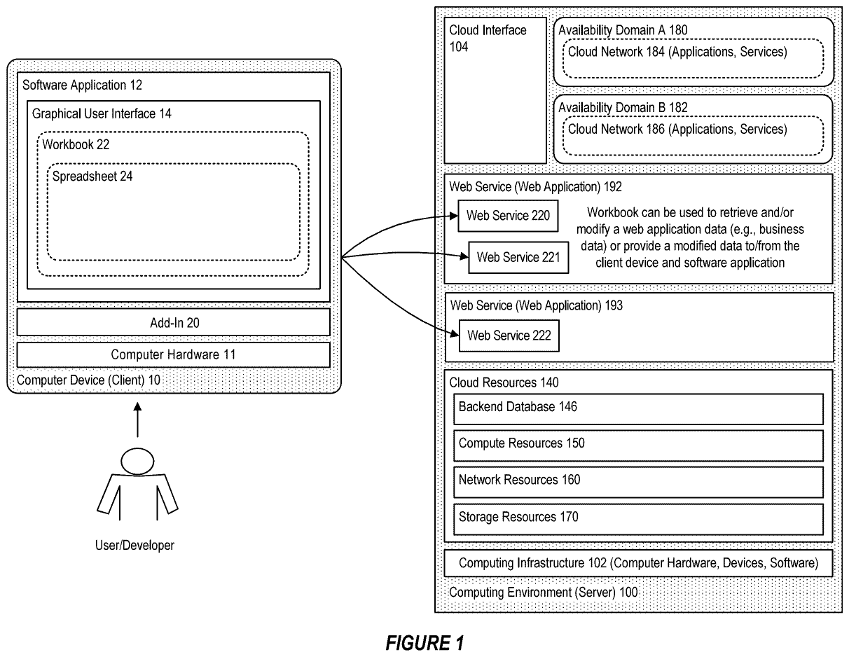

FIG. 1 illustrates a system for use of spreadsheets integrated with web services, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The examples illustrated therein are provided for purposes of illustrating a computing environment that can provide use of spreadsheets integrated with web services. In accordance with other embodiments, the various components, processes, and automated features described herein can be used with other types of computing environments.

As illustrated in FIG. 1 in accordance with an embodiment, a computing environment (e.g., a cloud environment, or server) 100 can operate on a computing infrastructure 102 comprising hardware (e.g., processor, memory), software resources, and provide a cloud interface 104 or other application program interface (API) that provides access to shared resources 140, such as, for example, a compute resources layer 150, a network resources layer 160, and/or a storage resources layer 170.

In accordance with an embodiment, the computing environment can support the use of availability domains, such as for example availability domains A 180, B 182, which enables customers to create and access cloud networks 184, 186, and run cloud instances.

In accordance with an embodiment, a client device, such as, for example, a computing device 10 having a device hardware 11 (e.g., processor, memory), a software application 12 (e.g., a spreadsheet application), and graphical user interface 14, can enable a user to communicate with the computing environment via network such as, for example, a wide area network, local area network, or the Internet, to access various applications, e.g., enterprise applications, including creating one or more workbook 22 or spreadsheet 24.

In accordance with an embodiment, web services 220, 221, 222 operate to receive requests directed to one or more web applications 192, 193.

For example, in accordance with an embodiment, a client device having a software application and graphical user interface can use a workbook or a software application document, for example a spreadsheet-type document, or other type of application document, to access a business object or web service to retrieve and/or provide a modified data to/from a web application.

In accordance with an embodiment, the web service can be, for example, a REST-based service, or other type of web service provided within an integration environment, that allows operations (e.g., GET, POST, PATCH, or DELETE operations) on a particular resource or object type (e.g., an expense reports object).

For example, in accordance with an embodiment, a business object can be provided and made accessible as a web service by an underlying service framework such as, for example, an Oracle REST Data Services environment, or a NetSuite environment, or other environment that allows client devices to communicate via web services and perform operations on associated business objects.

In accordance with an embodiment, a service-interface add-in 20 for use in software development can be provided, for example, as a software extension or add-in component, which operates both as a design tool, and as a runtime process, for purposes of integrating use of spreadsheets with web services.

In accordance with an embodiment, examples of software application environments can include spreadsheet-type software application or integration environments that can use workbooks, such as, for example, a Microsoft Excel or other type of spreadsheet-type software application.

In accordance with an embodiment, examples of software extension or add-in components can include, for example, an Oracle Visual Builder environment, configured as described herein, and which can be provided for use with a software application development environment, for purposes of developing workbooks.

In accordance with an embodiment, the workbook can be a software application document, for example a spreadsheet-type document, or other type of application document, that contains a catalog metadata that the software extension or add-in component can use to interact with a web service or other integration environment (for example, a REST-based service, or other type of web service), on behalf of a business user, together with a layout metadata that defines one or more graphical user interface layouts associated with the workbook.

In accordance with an embodiment, within a workbook, each layout provides a binding of a business object to a worksheet, as defined by a workbook metadata, for purposes of allowing operations on the business object, and integrating use of the spreadsheet with one or more web services.

In accordance with an embodiment, each workbook (e.g., spreadsheet-type document, or other type of software application document) can be considered a stand-alone application; with its only dependencies being its associated web service, the software application environment (e.g., a Microsoft Excel or other type of spreadsheet-type software application environment), and the software extension or add-in component.

In accordance with an embodiment, the add-in works directly with the web service to fetch and update data for the business user. Integrated workbooks are self-contained in that the required metadata is contained within the workbook, and can be distributed via various channels, for example via a Customer Connect channel, or embedded in web applications. Software application developers, information technology consultants, and customers can install the add-in, to design, create and test spreadsheet integrations directly on their desktop, with no dependency on another IDE or development environment.

In accordance with an embodiment, the layout forms a basis for integration of the web service (e.g., a business object) and the worksheet; and defines the aspects of the integration. For example, it can contain the set of desired table columns and their order; which of the available operations are enabled; or search/filter criteria used at data download time. A workbook can have multiple worksheets; and each worksheet can have a single layout.

In accordance with an embodiment, a client device can interrogate a web service to obtain web service metadata that determines one or more capabilities of that web service. For example, a client device 10 can send a request to a web service 220 requesting metadata, in response to which the web service can provide metadata describing which services, resources, or business objects that web service provides. The add-in can then use this information to configure a worksheet with a layout, for example to configure a spreadsheet-type document with a corresponding table component, based on the web service metadata. The table component can then be used to retrieve, display, edit, or communicate data within a spreadsheet, and upload user-made changes back to the web service.

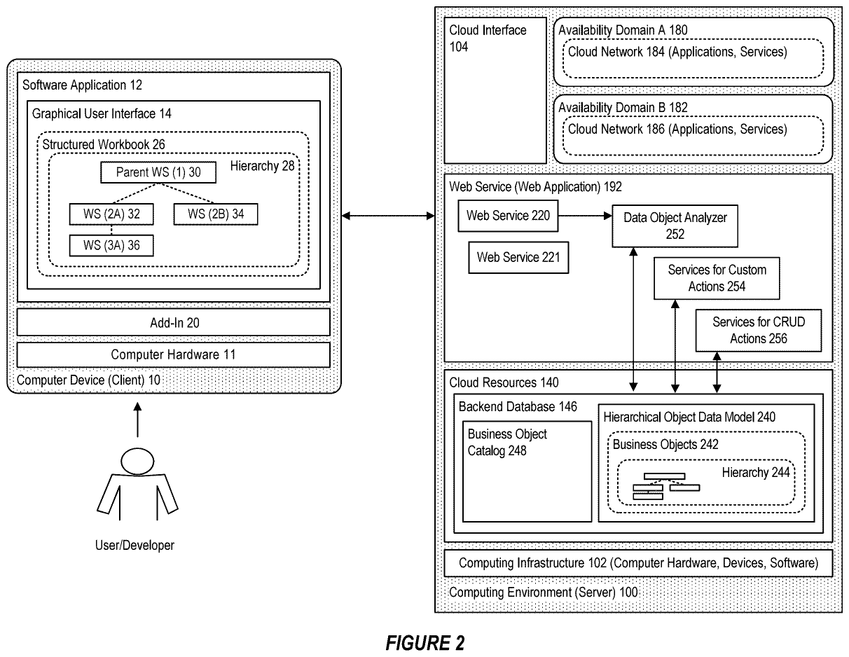

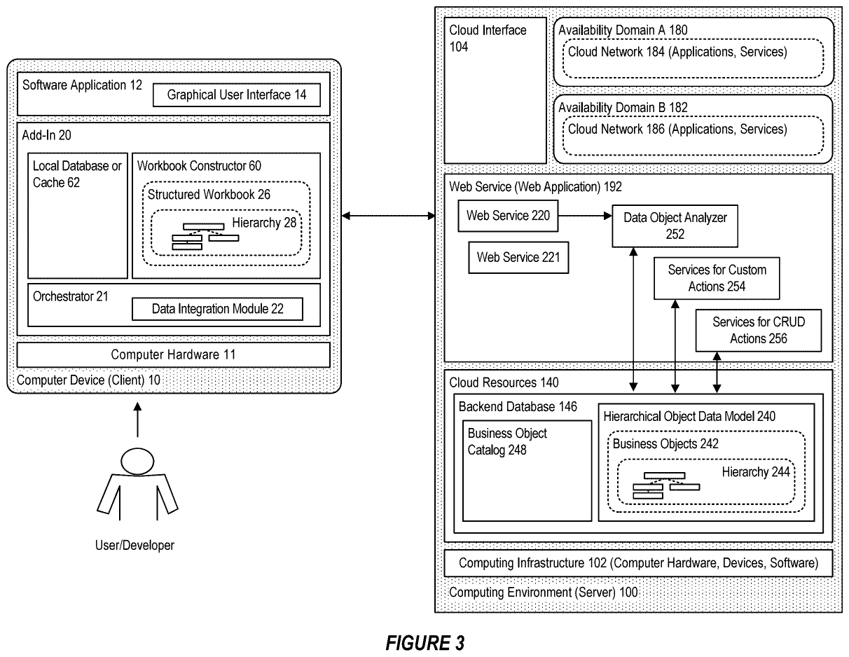

FIGS. 2 and 3 further illustrate a system for use of spreadsheets integrated with web services, including support for a hierarchical object data model, in accordance with an embodiment.

In accordance with an embodiment, FIG. 2 illustrates an example system and accompanying computing environment employing a client-side spreadsheet and accompanying service-interface add-in to interact with web services or Application Programming Interfaces (APIs) to facilitate operations, e.g., CRUD operations, on multi-dimensional hierarchically structured server-side data (e.g., corresponding to a hierarchical object data model 240) using a similarly multi-dimensional hierarchically related arrangement of spreadsheets (e.g., corresponding to a hierarchy of worksheets).

The example system includes one or more client systems (e.g., desktop computer, mobile device, etc.) in communication with a server system via a network, such as the Internet. The server system communicates with one or more backend databases 146. The server system runs one or more web services or APIs, which facilitate interaction between the one or more client systems and data and functionality maintained or provided via the backend databases.

The example client system(s) includes a spreadsheet (also called the client-side spreadsheet) with a service-interface add-in 20 and structured workbook 26.

The example web services (also called cloud-based services) of the server system include a data object analyzer 252, one or more services for facilitating implementing custom actions 254, and one or more services 256 for facilitating implementing CRUD operations.

The example backend databases include a business object catalog 248 and one or more hierarchical object data models (also called data structures herein).

Note that in general, groupings of various modules of the system are illustrative and may vary, e.g., certain modules may be combined with other modules or implemented inside of other modules, or the modules may otherwise be distributed differently (than shown) among a network or within one or more computing devices or virtual machines, without departing from the scope of the present teachings. For example, while the backend databases are shown separately from the server system, the backend databases may be part of the server system, without departing from the scope of the present teachings.

For instance, while the business object catalog and hierarchical object models may be implemented by a relational database that is used for persistence of the hierarchical object data models and accompanying data, other embodiments are possible. For instance the business object catalog hierarchical object data models may be implemented in the server system, e.g., via one or more web services and/or APIs and/or other module in communication therewith.

For example, a separate box (i.e., separate from the web services or APIs) may represent a module that incorporates functionality for communicating with, managing, and/or exposing the business object catalog and accompanying hierarchical object data models to the one or more client systems. The backend database(s) may influence the hierarchy, but, alternatively, may be used only for storage of data. Accordingly, in this example case, the business object data models and accompanying hierarchies can be implemented, in whole or in part, via one or more modules running on the server system.

In the example embodiment, the backend databases include business objects 242 that are hierarchically related in accordance with the hierarchical object data model; graphically depicted here via a data hierarchy 244. For instance, a given parent object may have one or more child objects (called children), and the children may also have one or more child objects.

The client-side structured workbook of the spreadsheet has been configured with client-side hierarchy 28 of worksheets, including a parent worksheet (WS) 30, a first child worksheet (WS 2a) 32, a second child worksheet (WS 2b) 34, and a grandchild worksheet (WS 3a) 36. These worksheets of the structured workbook have been associated, related, or otherwise linked to each other to establish the client-side hierarchical structure.

Associations, relations, or links between the worksheets and construction of the worksheets can be automatic and/or manual. During automatic configuration, the service-interface add-in obtains or accesses information about the server-side hierarchical object data model and accompanying business objects and hierarchical relationship structure (also called server-side hierarchy herein).

The service-interface add-in may obtain this descriptive information describing the server-side hierarchy and associated business object model responsive to one or more request messages sent by the service-interface add-in to the data object analyzer.

The data object analyzer may be a service that selectively accesses a business object catalog, which contains descriptive information, e.g., descriptions of business object hierarchies and data models, of the backend databases. The descriptive information can include relationship keys describing, for instance, how each of the hierarchically related business objects are related to each other (e.g., parent object, child object, sibling object, grandchild object, and so on).

The data object analyzer then delivers a response message with the descriptive information to the service-interface add-in responsive to the request message issued therefrom. The service-interface add-in includes code for automatically constructing the structured workbook and generating the initial worksheets.

The worksheets are then related to each other so that the worksheet hierarchy models a portion of, e.g., a subset of, (or all of, depending upon a given implementation) server-side hierarchy. Hence, the structure of the worksheet hierarchy (also called client-side hierarchy herein) matches a portion of the structure that includes data objects with data corresponding to data of the worksheets at similar levels of the data structure 240.

Note that the service-interface add-in may include computer code for controlling certain UI functionality of the spreadsheet. For instance, during manual structuring of relationships among the worksheets, a user may access one or more menus for selecting parent worksheets for given worksheets, and so on.

The service-interface add-in may control the availability of certain user options in such menus. For instance, the service-interface add-in may reference knowledge of the server-side hierarchy (244) to ensure that inappropriate relationships between the worksheets are not established, i.e., menu options for such are not provided during a manual configuration mode.

Structuring relationships between the worksheets in accordance with the server-side hierarchy, which characterizes the hierarchically related business objects of the hierarchical object data model, facilitates consistent interaction, synchronization, orchestration, including CRUD operations, which can now readily be implemented across complex data object hierarchies via a user-friendly UI of the spreadsheet.

In accordance with an embodiment, FIG. 3 illustrates additional detail of the service-interface add-in of the spreadsheet of the example system and accompanying computing environment of FIG. 2.

In accordance with an embodiment, the example service-interface add-in includes an example workbook constructor module 60 in communication with the web services, and in particular, the data object analyzer thereof. The workbook constructor includes code for selectively calling the data analyzer to obtain information about the hierarchical object data model and accompanying hierarchically related business objects, in addition to information about the server-side hierarchy itself, including relationships between constituent objects and sub-objects thereof.

The data object analyzer may include code for checking the business object catalog for suitable descriptions of the hierarchical object data model, and then retrieving the descriptions, so as to fulfill requests for such descriptions (which may include relationship keys identifying and describing relationships between different objects of the hierarchical object data model issued by the client-side workbook constructor.

The descriptions of the objects of the hierarchical object data model and accompanying objects and hierarchies can then be stored in a local database or cache for use by the workbook constructor 60 when constructing the worksheet hierarchy for use with the structured workbook and accompanying spreadsheet program of FIG. 2.

When building the worksheet hierarchy, the workbook constructor uses the information describing the data model (e.g., as may be obtained from the data object analyzer and business object catalog, or as may be retrieved from the local database or cache if already stored there) to construct the worksheet hierarchy using descriptive parameters or attributes that establish hierarchical relationships between the worksheets, such that the spreadsheet hierarchy parallels or mimics a portion of the server-side hierarchy.

With reference to FIGS. 2 and 3, each of the different worksheets (30-36) may be associated with a corresponding server-side data object of the server-side hierarchically related business objects. For instance, during workbook construction by the workbook constructor, the parent worksheet and data therein may correspond to a parent object of the hierarchically related business objects. Similarly, the first child worksheet may correspond to a first child object of the parent object of the hierarchically related business objects.

The service-interface add-in includes an orchestrator module and accompanying data integration module 22. The example orchestrator 21 includes code for facilitating implementation of orchestration of operations, e.g., CRUD operations, data synchronizations, implementation of custom actions (e.g., using data/parameters input from the spreadsheet), and so on, between the client-side spreadsheet and the server-side hierarchical object data model, via strategic use of the web services.

Furthermore, in the example embodiment, the orchestrator module of the service-interface add-in communicates with the local database or cache 62 and the workbook constructor. The orchestrator includes code for performing various functions, such as determining any changes or scheduled actions to any portions of the worksheets of the worksheet hierarchy; then determining when a user has selected to implement the changes (e.g., by detecting selection of an upload button); then traversing the worksheet hierarchy to package proposed changes, actions, operations, etc. into one or more request messages.

The one or more request messages are then sent to the web services, e.g., to the one or more services for implementing CRUD operations, and/or to the one or more services for implementing custom actions.

The request messages sent from the orchestrator and accompanying data integration module to the web services may include descriptive information indicating to the web services, which particular level and which particular business objects of the server-side hierarchy is/are to be operated on in accordance with the one or more request messages issued by the orchestrator and/or accompanying data integration module.

The web services may return status information, e.g., indicating whether or not a particular operation or action was successfully completed or not. This status information may then be subsequently displayed in the workbook and associated spreadsheets (30-36).

The orchestrator may also access the local database or cache to determine descriptive information of the server-side hierarchically related business objects and the client-side hierarchy of worksheets, and may then use that descriptive information to facilitate selectively updating the workbook and accompanying worksheets.

For instance, if the orchestrator determines that a user would like to download data for a parent worksheet, in response to user selection of a download button, the orchestrator may determine that the parent worksheet represents a parent node worksheet. Accordingly, when issuing a request message to the services for CRUD operations, the request message issued by the orchestrator may include descriptive information specifying retrieval of data from the corresponding parent data object of the server-side hierarchy.

Also note that in certain embodiments, if a given workbook includes worksheets that have not yet been populated with data, user selection of a download button may populate all of the worksheets with corresponding data from the hierarchical object data model, and data from different objects of that object data model will be positioned into corresponding worksheets at the corresponding hierarchical level.

### Custom Actions

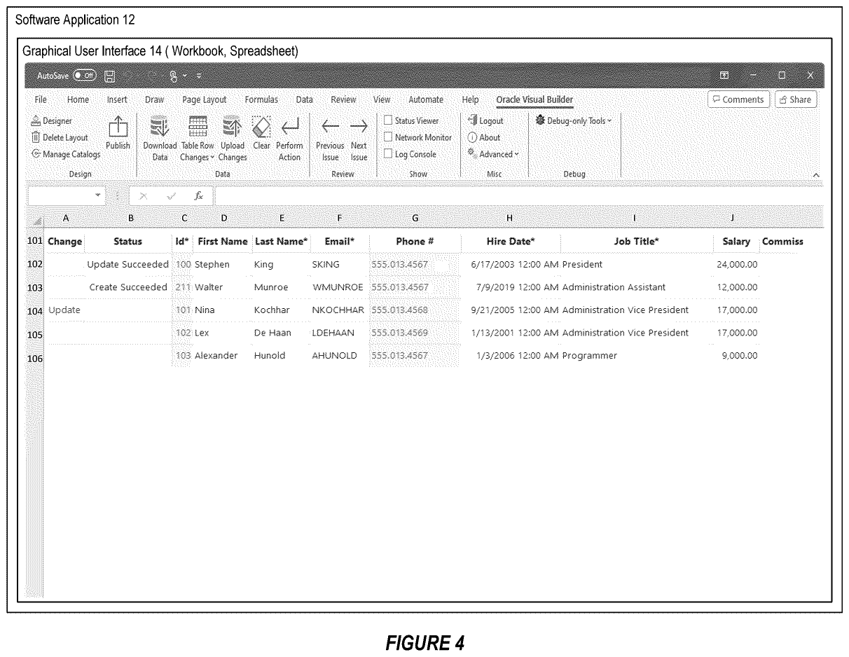

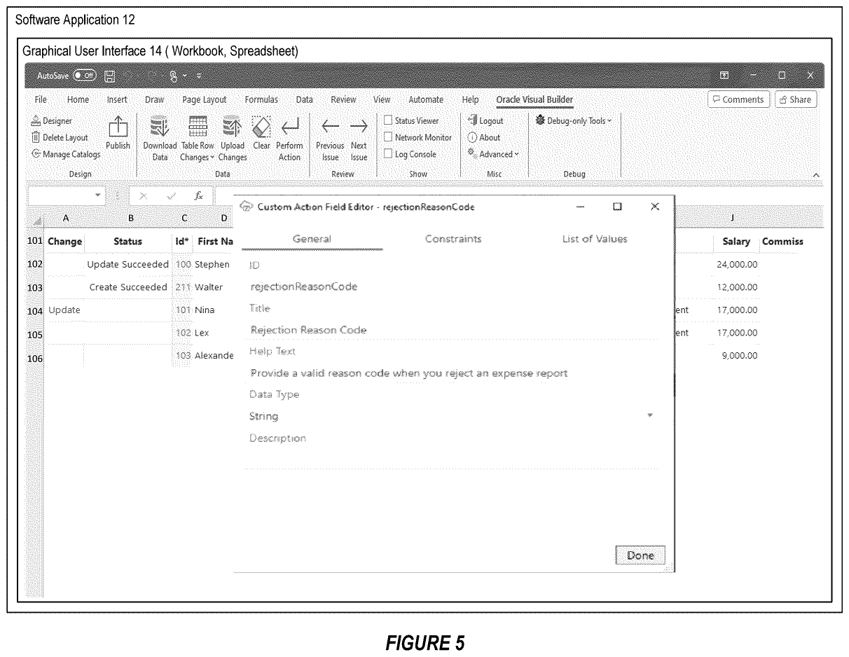

FIGS. 4 and 5 illustrate the use of spreadsheets integrated with web services, including support for (e.g., row status) custom actions, in accordance with an embodiment.

In accordance with an embodiment, a custom action is a function defined by an e.g., REST-based web service that is callable by external systems using REST POST requests. The operation a custom action performs when invoked by the add-in is determined by the service. The add-in sends a POST on the collection or item path that includes the action name, such as/contextRoot/v1/myBusObj/{itemId}/action/doMyAction for a business object item.

This POST can include payload field values, known as “parameters”, to the service. The service then takes the passed parameters and performs the custom action. This action may act on a single row when defined at the row level. When the action is defined at the business object level, the service determines which rows, if any are affected.

In accordance with an embodiment, a custom action may accept zero or more parameters of simple types such as a String or Integer and returns a single value to the add-in, which is then displayed in the “Status” Viewer. This result returned by the service may be a simple scalar value like a string or a more complex non-scalar value like an array.

For example, a service may have a custom action defined at the business object (BO) level. Examples of custom actions at the business object item level might be a couple of custom actions, “Approve” and “Reject”, that operate on the items of a expense report business object. A business user can download one or more expense reports, approve or reject each one, and then update them all in a single upload.

In accordance with an embodiment, if a given REST API supports custom actions, they are described in the service's OpenAPI service metadata. The add-in can analyze this service metadata, harvest custom action definitions, and include them in the workbook's corresponding business objects.

Item level custom actions can be performed on items in either the form or the table of a Form-over-Table layout, as well as on rows in a Table layout. Business object level custom actions can be performed on business objects in a Table layout and the form in a Form-over-Table layout.

As illustrated in FIGS. 4-5, in accordance with an embodiment, custom actions exposed by the service that a workbook uses can be viewed and edited in a Custom Actions tab of the business object editor.

In accordance with an embodiment, the add-in populates this editor with the custom action properties as described in the service's OpenAPI service metadata.

In accordance with an embodiment, the Title, Help Text, and Description properties can be edited as needed in the Custom Action Editor. Other properties, ID, Path, and Request Media Type, reflect the service configuration.

Title: The name of this custom action. A short value that is meaningful to business users. This value appears wherever business users can invoke the action.

Help Text: A brief explanation of what the custom action does. This value appears near the Title when possible.

Properties such as the Title, Data Type, and Required can be changed. For example, the user can change the data type of a payload field from String to Integer, as long as the change is compatible with the service. The user can also update the Required property to mark the payload field as required or not.

In accordance with an embodiment, if the service a workbook uses includes custom actions on individual items of a business object, the user can add defined custom action payload fields to a Table layout or the table part of a Form-over-Table layout—for example, a “reject” custom action that is exposed by an expense report business object to reject expenses.

In accordance with an embodiment, if a given REST API supports custom actions, they are described in the OpenAPI service metadata generated by the ADF REST Resource service. For example, a reject item-level custom action would appear in the paths collection:

```
“/ExpenseReports/ {ExpenseReports_Id} /action/reject”: {
  “parameters”: [
    {
      “$ref”: “#/components/parameters/ExpenseReports_Id”
    }
  ],
  “post”: {
    “summary”: “reject”,
    “description”: “reject”,
    “operationId”: “do_reject_ExpenseReports”,
    “responses”: {
      “default”: {
        “description”: “The following table describes the
          default response for this task.”,
        “content”: {
          “application/vnd.adf.actionresult+json”: {
            “schema”: {
              “type”: “object”,
              “properties”: {
                “result”: {
                  “type”: “string”
                }
              },
              “required”: [
                “result”
              ],
              “additionalProperties”: false
            }
          }
        }
      }
    },
    “requestBody”: {
      “description”: “The following table describes the body parameters
        in the request for this task.”,
      “content”: {
          “application/vnd.adf.action+json”: {
            “schema”: {
              “type”: “object”,
              “properties”: {
                “rejectionReasonCode”: {
                  “type”: “string”,
                  “nullable”: true
                },
                “notes”: {
                  “type”: “string”,
                  “nullable”: true
                }
              },
              “additionalProperties”: false
          }
        }
      }
    }
  }
}
```

### Row Status Custom Actions

Business data-related information often resides in multiple locations. For example, a particular web service may provide rows of business data for viewing and editing, while the validation or error information associated with that business data may be stored in a different location, or provided by a different web service accessible via a separate interface.

Other business-related information, such as recommendations, may necessitate the use of yet another source of information or interface. While business users may want to manage their data in a familiar spreadsheet format, present systems do not integrate the information from various sources in a coherent fashion.

In accordance with various embodiments, the system provides a process for combining or aggregating information from multiple endpoints such as web services or other sources, within a spreadsheet interface, for example to enable viewing of errors, validation failures, policy warnings, recommendations, or other information; fetching and displaying additional information relevant to existing business data; or providing access to additional services, for example generative artificial intelligence (generative-AI, gen-AI) services, to incorporate recommendations or information provided by those services.

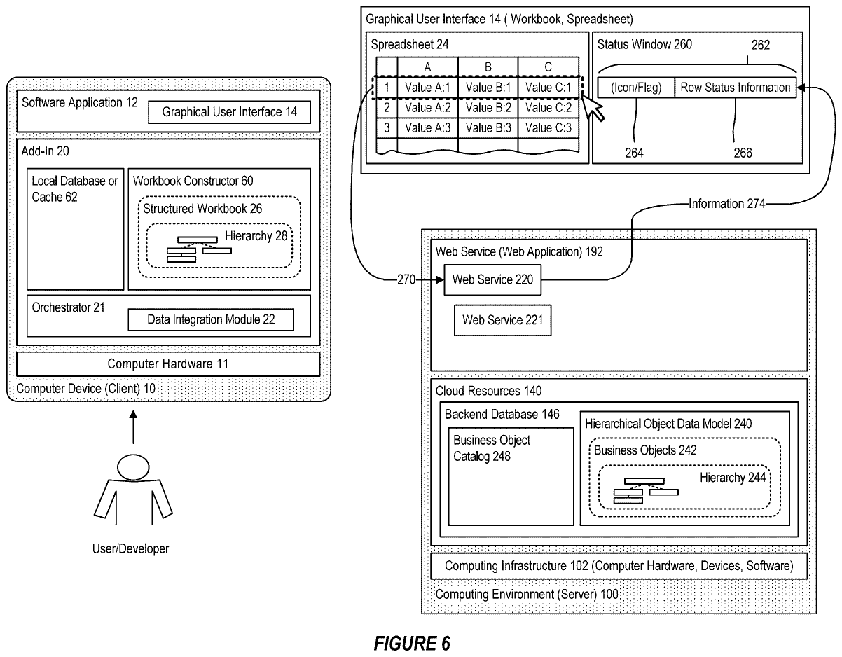

FIG. 6 illustrates how the system can be used to combine related information from multiple web services or other sources, in accordance with an embodiment.

As described above, in accordance with an embodiment, a client device can interrogate one or more web services to obtain web service metadata that determines one or more capabilities of those web services. This metadata can be used to automatically configure an editable table component in a spreadsheet, for use in retrieving, editing and uploading data to a web service, or providing validations, recommendations, or other functionalities.

As also described above, in accordance with an embodiment, a custom action can be defined by a web service that is callable using REST POST requests. The operation a custom action performs when invoked by the add-in can be determined by the service.

As illustrated in FIG. 6, in accordance with an embodiment, the system can display within the user interface a row status window 260 that displays information 262 associated with one or more rows of data or cells for user review or action. Each row of data or cell can, for example, be associated with an informative icon 264 and/or row status information 266 related to that row or cell.

In accordance with an embodiment, as the user interacts with the spreadsheet and with particular rows of data or particular cells, the system can automatically communicate 270, for example via POST requests, with one or more web services or other sources.

In accordance with an embodiment, in response to POST requests, each of the one or more services can provide a response, for example as a row status custom response body. The system can then combine or aggregate related information 272 received from the web services or other sources, within the spreadsheet interface, for use in displaying a row status associated with the data.

In accordance with an embodiment, if a custom action supports a multi-row mode, the add-in can process custom actions and other types of changes in batches. Custom actions on individual items are sent as separate requests. A custom action associated with a business object may update multiple items in the business object, but is accomplished using a single request.

In accordance with an embodiment, to enable the add-in to process changes in batches, the user can configure a “Supports Multi-Row Requests” check box in a Custom Action Editor. If the check box is not selected, the add-in invokes the custom action one row at a time. The configuration information can be stored in the catalog metadata that the software extension or add-in component uses to interact with web services or other integration environments.

In accordance with an embodiment, a system operating according to the approach described herein can be used to aggregate related information about a business data derived from multiple data sources, by providing standards as to how the row status information is requested and transferred, including for example suggesting AI-determined changes or other information.

In accordance with an embodiment, for example, the user can select a number of rows and indicate a “Get Row Status” to upload a request for information as a POST request to one or multiple REST URL's, for example one or more business expense objects. A response body can then provide a “result” with an associated row status information or summary.

In accordance with an embodiment, developers of web services can expose their REST-based web service via a URL that conforms to the response body and “result” format, in order to return the appropriate information, which allows the system to return multiple “results” from one or more, or from multiple web services.

In accordance with an embodiment, the described approach is not restricted to use cases that involve modifying a data present with a workbook or spreadsheet, but can instead be generally directed to combining or aggregating information as to the status of various rows of data, such that a single row status custom action and associated request can be used to obtain relevant information from multiple sources.

In accordance with an embodiment, a row status custom action and associated request can be invoked automatically when a user selects a spreadsheet row. Such row status custom actions can be invoked multiple times in parallel. The option to configure how row status custom actions should be executed, i.e., whether the associated requests made by the add-in should be performed sequentially or in parallel, can be exposed within the workbook designer and be configurable by the workbook developer. Generally, it would not be evident to an end user whether the requests being made by the add-in are being performed sequentially or in parallel.

In accordance with an embodiment, the system can support additional features, for purposes of providing data validations, and also for supporting features such as policy warnings, or suggested data—including, for example, AI-determined information pertaining to the rows of data. For example, a custom row action can access an AI-related web service if the REST endpoint is appropriately defined or has a shape as described above to populate a response body with “results”.

In accordance with an embodiment, when configured a row status custom action should: be a row-level custom action; report the current state of the row without changing the row state, or field values, etc.; and return row status information in a row status custom action response schema.

In accordance with an embodiment, to designate a custom action as a row status custom action, the user can use a Custom Action Editor to configure a “Returns row status” and provide a row status custom action response schema (for example, as a JSON Schema: row-status-custom-action-result.json). Custom actions return a JSON object with a “result” property. The contents of the “result” property for a row status custom action are an array of row status item objects that contain various properties, for example:

| Property Name | Required | Default Value | Allowed Values |
|---|---|---|---|
| Path | no | | A valid field ID of a field defined on the business |
| | | | object that is bound to the layout. If a value is |
| | | | omitted, the message is considered relevant to |
| | | | the entire row instead of a specific field |
| Summary | yes | | A localized string, no markup allowed |
| Detail | no | | A localized string, no markup allowed |
| Type | no | info | info \| error \| warning |

Continuing with the example illustrated in FIG. 6, using the above-described approach, as the user interacts with a spreadsheet and with particular rows of data or particular cells, the system can automatically communicate with, receive responses, and combine or aggregate related information from one or more web services or other sources, within the spreadsheet interface, and display a row status associated with the data, for example to display an error, warning, recommendation, or other information associated with the data.

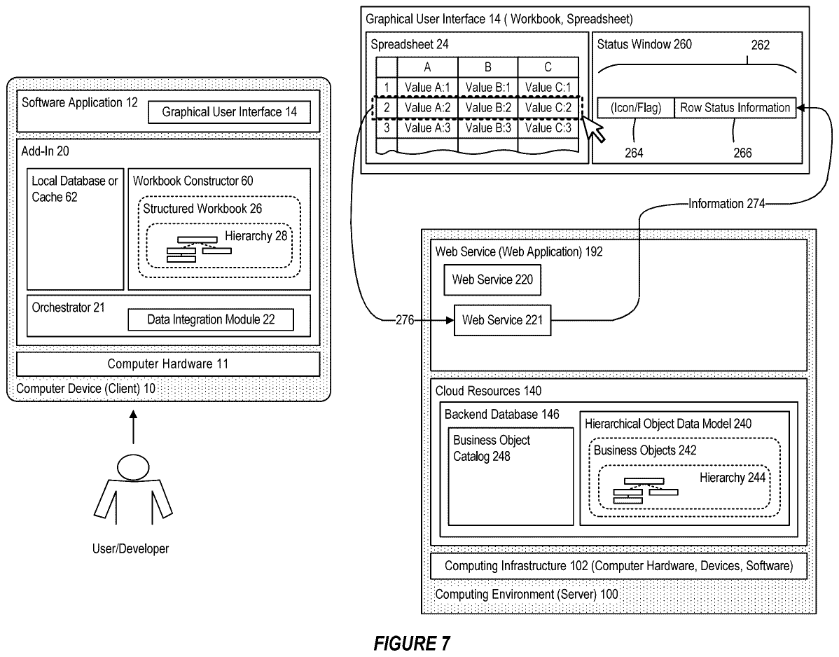

FIG. 7 further illustrates how the system can be used to combine related information from multiple web services or other sources, in accordance with an embodiment.

As illustrated in FIG. 7, in accordance with an embodiment, in response to user interactions to select other rows of data or cells, the system continues to automatically communicate 276 with one or more web services or other sources, receive responses, and automatically communicate with, receive responses, and combine or aggregate related information from the one or more web services or other sources of data or information, and display an updated row status associated with the other rows of data or cells.

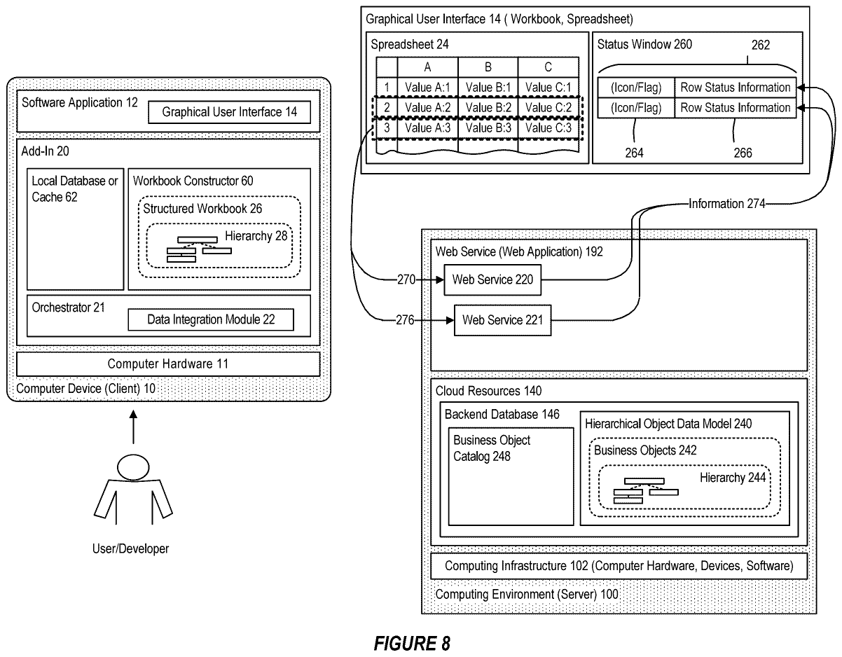

FIG. 8 further illustrates how the system can be used to combine related information from multiple web services or other sources, in accordance with an embodiment.

As illustrated in FIG. 8, in accordance with an embodiment, the system can automatically communicate with, receive responses, and combine or aggregate related information, in parallel, from a plurality of web services or other sources, within the spreadsheet interface, and display or update a row status associated with the data, based on the information received from the plurality of web services or other sources and associated with the particular rows of data or particular cells.

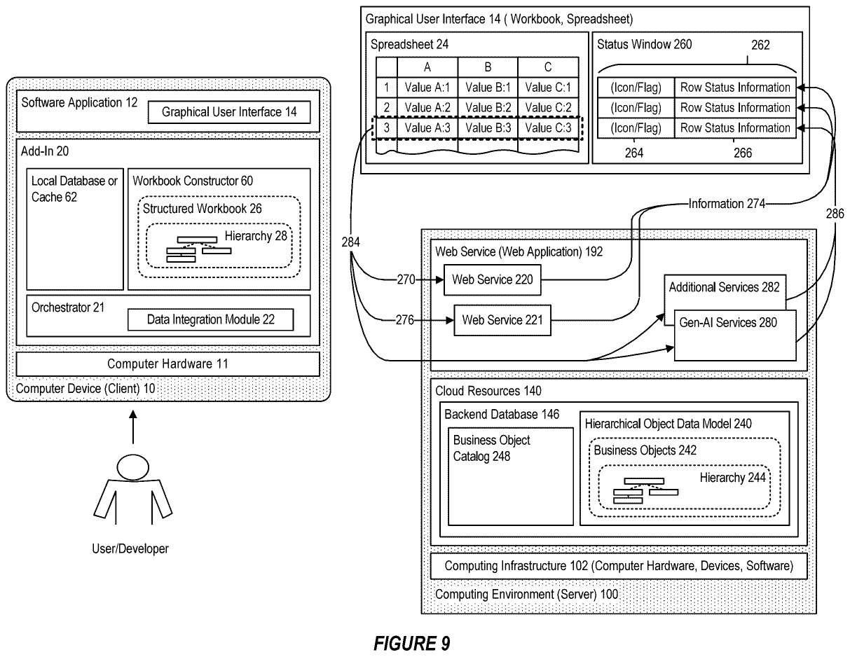

FIG. 9 further illustrates how the system can be used to combine related information from multiple web services or other sources, in accordance with an embodiment.

As illustrated in FIG. 9, in accordance with an embodiment, the system can use the described approach to provide access to additional services 280, for example generative artificial intelligence (generative-AI) services 282, to incorporate recommendations or information 286 provided by those services.

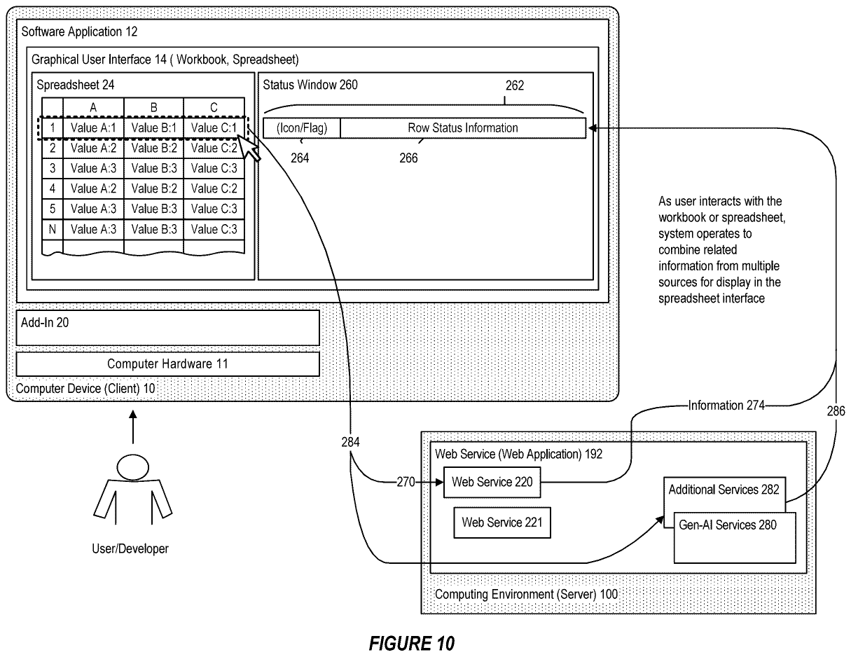

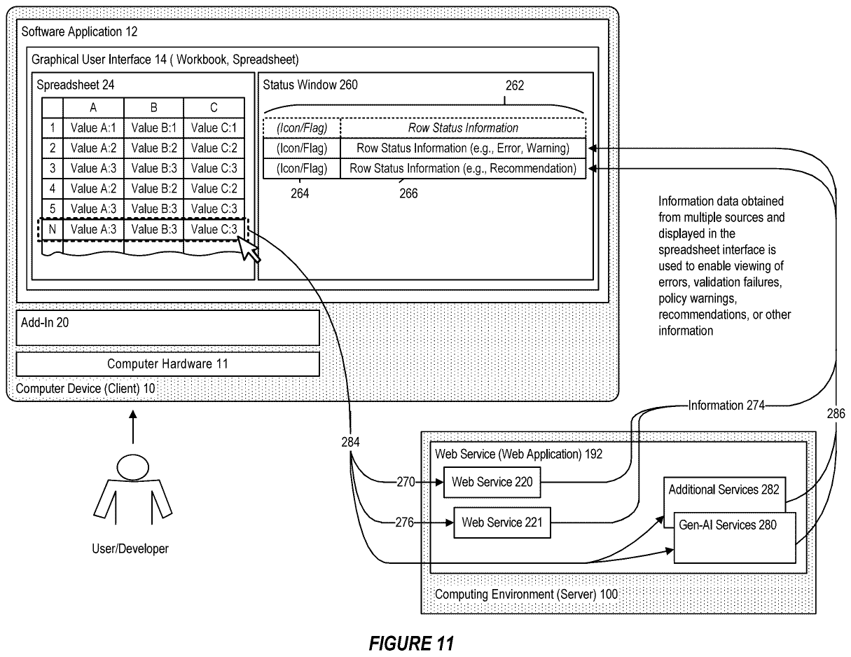

FIGS. 10-11 further illustrate how the system can be used to combine related information from multiple web services or other sources, in accordance with an embodiment, illustrating how a user interacts with the workbook or spreadsheet, wherein the system operates to combine related information from multiple sources for display in the spreadsheet interface; and how information data obtained from multiple sources can be displayed in the spreadsheet interface and used to enable viewing of errors, validation failures, policy warnings, recommendations, or other information.

### Example Response—Rejection Messages

In accordance with an embodiment, by way of example, a service can provide a rejection message as part of a row status custom response body.

```
{“result”: [
    {
      “path”: “invoiceNumber”,
      “summary”: “Duplicate Invoice Number”, “detail”:
      “Invoice numbers must be unique.”, “type”: “error”
    },
    {
      “path”: “amount”,
      “summary”: “Invalid Amount”, “type”: “error”
    }
  ]
}
```

### Example Response—Information/Suggestion

In accordance with an embodiment, by way of example, a service can provide an information or suggestion as part of a row status custom response body.

```
{“result”: [
    {
      “summary”: “A similar item is available from Acme Corp at a lower price”,
      “type”: “info”
    }
  ]
}
```

### Example Response—Warning

In accordance with an embodiment, by way of example, a service can provide a warning as part of a row status custom response body.

```
{“result”: [
    {
      “path”: “amount”,
      “summary”: “The expense report exceeds the standard limit and requires special approval”,
      “type”: “warning”
    }
  ]
}
```

The above examples are provided for illustrative purposes, to illustrate various types of responses that can be provided by services as part of a row status custom response body. In accordance with various embodiments, the systems and methods described herein can be used to support other types of responses.

### Automatic Invocation on Selection

In accordance with an embodiment, the described approach can be used to invoke a custom action for a row automatically when any cell in the row of a table layout is first selected. To enable automatic invocation of the row status custom action, the user can use a menu interface to configure the behavior of the service add-in and row status custom action to be invoked automatically. The result of the row status custom action is cached, and the custom action will not be invoked on selection again until the layout is cleared; the layout is downloaded; or the row is successfully uploaded.

### Status Reporting

In accordance with an embodiment, after a row status custom action executes successfully, the status column in a table layout can report a summary of the results, for example: “{Custom Action Title}: {Most severe type found in response}”. When a cell in the row is selected, the status viewer can display contextual status information for the row, for example a rejection message; an info/suggestion; or a warning, as illustrated above.

### Example User Experience

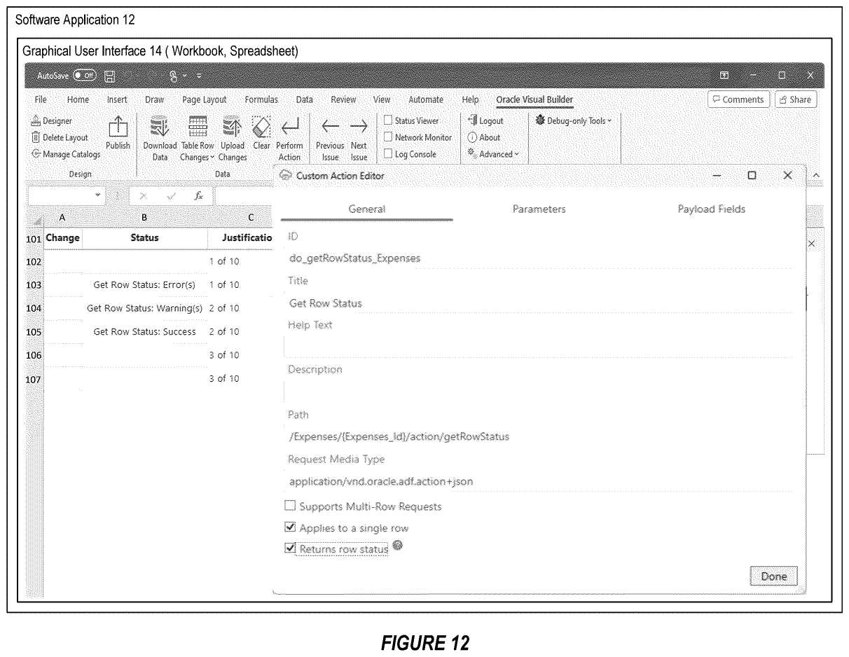

FIG. 12 illustrates an example for combining related information from multiple endpoints such as web services or other sources, within a spreadsheet interface, in accordance with an embodiment.

As illustrated in FIG. 12, in accordance with an embodiment, a user can configure the add-in via the custom action editor to return a row status, and to support multi-row requests, or apply custom actions to single rows.

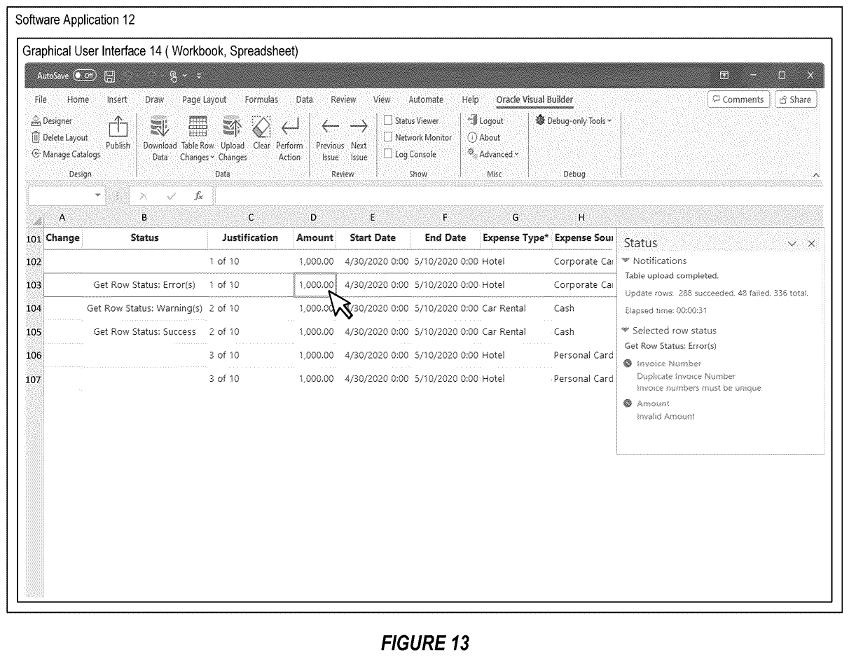

FIG. 13 further illustrates an example for combining related information from multiple endpoints such as web services or other sources, within a spreadsheet interface, in accordance with an embodiment.

As illustrated in FIG. 13, in accordance with an embodiment, as the user interacts with a spreadsheet and with particular rows of data or particular cells, the system can automatically communicate with, receive responses, and combine or aggregate related information from one or more web services or other sources, within the spreadsheet interface, and display a row status associated with the data, for example to display an error associated with the data.

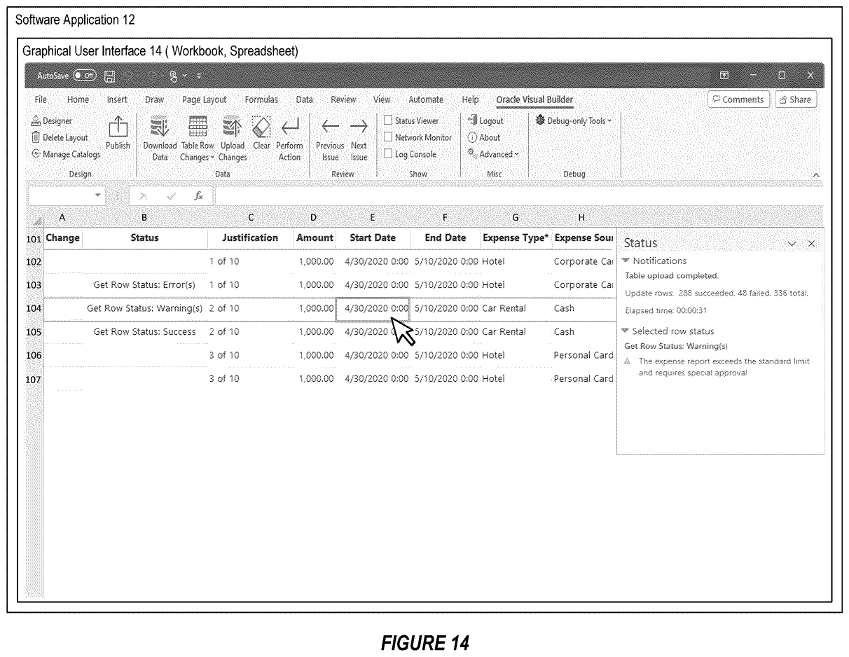

FIG. 14 further illustrates an example for combining related information from multiple endpoints such as web services or other sources, within a spreadsheet interface, in accordance with an embodiment.

As illustrated in FIG. 14, in accordance with an embodiment, as the user continues to interact with the spreadsheet, for example to select other rows of data or cells, the system can continue to automatically communicate with, receive responses, and combine or aggregate related information from one or more web services or other sources and display a row status, for example to display a warning associated with the data.

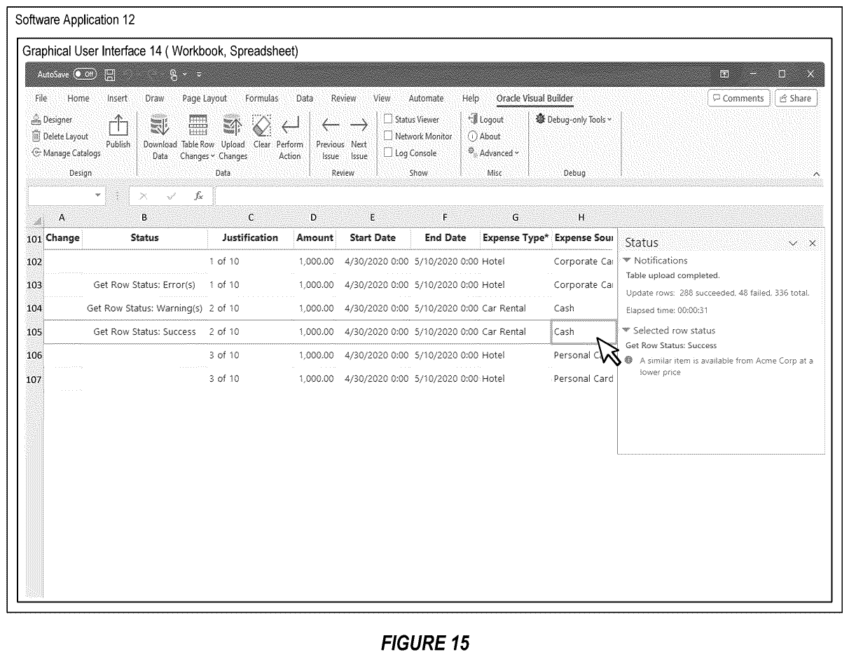

FIG. 15 further illustrates an example for combining related information from multiple endpoints such as web services or other sources, within a spreadsheet interface, in accordance with an embodiment.

As illustrated in FIG. 15, in accordance with an embodiment, as the user continues to interact with the spreadsheet, for example to select yet other rows of data or cells, the system can continue to automatically communicate with, receive responses, and combine or aggregate related information from one or more web services or other sources and display a row status, for example to display recommendations or other information associated with the data.

### Example Process

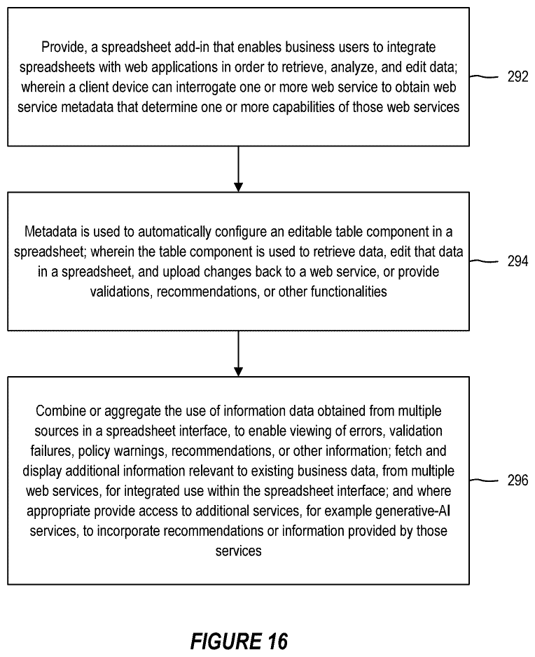

FIG. 16 illustrates a process for combining related information from multiple endpoints such as web services or other sources, within a spreadsheet interface, in accordance with an embodiment.

As illustrated in FIG. 16, in accordance with an embodiment, the process or method comprises, at step 292, providing a spreadsheet add-in that enables business users to integrate spreadsheets with web applications in order to retrieve, analyze, and edit data; wherein a client device can interrogate one or more web services to obtain web service metadata that determines one or more capabilities of those web services.

At step 294, metadata is used to automatically configure an editable table component in a spreadsheet; wherein the table component is used to retrieve data, edit that data in a spreadsheet, and upload changes back to a web service, or provide validations, recommendations, or other functionalities.

At step 296, the system operates to combine or aggregate the use of information data obtained from multiple sources in a spreadsheet interface, to enable viewing of errors, validation failures, policy warnings, recommendations, or other information; fetch and display additional information relevant to existing business data and where appropriate provide access to additional services, for example generative AI services, to incorporate recommendations or information provided by those services.

### Example Use Cases

In accordance with an embodiment, the systems and methods described herein can be used to provide additional functionality to business users with regard to integrating sources of information relevant to their business data, such as, for example:

Recommendations: the system can operate to call out to an external or other service, for example a generative-AI service, to analyze a current data row and provide useful recommendations to a business user. For example, in the context of a purchase order, the service might be able to suggest alternative products available at a better price or schedule.

Policy warnings: the system can operate to provide a business user with warnings associated with their existing data from a corporate policy perspective. For example, an expense report's details may be out of compliance with a corporate policy. The user can view the warnings and make corrections prior to submitting the expense report, instead of having it rejected at a later date.

Validation failures: with existing approaches, data may be validated in bulk using asynchronous background batch processes, resulting in a large number of errors that need to be corrected. To address this issue, the add-in can download a core data, and then integrate the error information (e.g., from a separate service) to facilitate the correction process.

Suggested data: the system can operate to return suggested values for missing data, such that the add-in can enter suggested data into the spreadsheet, where the business user can review and edit it as needed before uploading the final changes to the web service. For example, while managing a product catalog within a spreadsheet, the system can operate to suggest industry classifications for each product. The suggestions might be provided using simple algorithms or be provided by an external or other service, for example a generative-AI service. The suggested classifications can then be entered directly into the integrated data table ready to upload.

The above examples are provided for illustrative purposes, to illustrate various use cases supported by the systems and methods described herein. In accordance with various embodiments, the systems and methods described herein can be used to support other types of uses cases or applications.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for use of spreadsheets integrated with web services, including support for row status custom actions, comprising:
a client device operable to interrogate one or more web services to obtain web service metadata that determines one or more capabilities of those web services;
wherein the metadata is used by an add-component to automatically configure an editable table component in a spreadsheet, wherein the table component is used to retrieve data, edit the data in the spreadsheet, or upload changes back to the web service, or provide validations, recommendations, or other functionalities; and
wherein as the user interacts with the spreadsheet and with particular rows of data or particular cells, the system can automatically communicate with, receive responses, and combine or aggregate related information from one or more web services or other sources, within the spreadsheet interface, and display a row status associated with the data.

2. The system of claim 1, further comprising displaying a row status window that displays information associated with one or more rows of data or cells for user review or action, said information derived from one or more web services;
wherein in response to user interactions to select other rows of data or cells, the system continues to automatically communicate with, receive responses, and combine or aggregate related information from the one or more web services or other sources of data or information, and display an updated row status associated with the other rows of data or cells.

3. The system of claim 1, wherein as the user interacts with the spreadsheet and with particular rows of data or particular cells, the system automatically combines or aggregates related information, in parallel, from a plurality of web services or other sources, within the spreadsheet interface, and displays or updates a row status associated with the data, based on the information received from the plurality of web services or other sources and associated with the particular rows of data or particular cells.

4. The system of claim 1, wherein the system operates to combine or aggregate related information from multiple endpoints such as web services or other sources, within a spreadsheet interface, for use in performing business tasks, including one or more of:
viewing of errors, validation failures, policy warnings, recommendations, or other information;
fetching and displaying additional information relevant to existing business data or
providing access to additional services, for example generative artificial intelligence (generative-AI) services, to incorporate recommendations or information provided by those services.

5. The system of claim 1, wherein the system is provided as part of a cloud computing system.

6. A method for use of spreadsheets integrated with web services, including support for row status custom actions, comprising:
providing a client device operable to interrogate one or more web services to obtain web service metadata that determines one or more capabilities of those web services;
wherein the metadata is used by an add-component to automatically configure an editable table component in a spreadsheet, wherein the table component is used to retrieve data, edit the data in the spreadsheet, or upload changes back to the web service, or provide validations, recommendations, or other functionalities; and
wherein as the user interacts with the spreadsheet and with particular rows of data or particular cells, the system can automatically communicate with, receive responses, and combine or aggregate related information from one or more web services or other sources of data or information within the spreadsheet interface, and display a row status associated with the data.

7. The method of claim 6, further comprising displaying a row status window that displays information associated with one or more rows of data or cells for user review or action, said information derived from one or more web services;
wherein in response to user interactions to select other rows of data or cells, the system continues to automatically communicate with, receive responses, and combine or aggregate related information from the one or more web services or other sources of data or information, and display an updated row status associated with the other rows of data or cells.

8. The method of claim 6, wherein as the user interacts with the spreadsheet and with particular rows of data or particular cells, the system automatically combines or aggregates related information, in parallel, from a plurality of web services or other sources, within the spreadsheet interface, and displays or updates a row status associated with the data.

9. The method of claim 6, wherein the method operates to combine or aggregate related information from multiple endpoints such as web services or other sources, within a spreadsheet interface, for use in performing business tasks, including one or more of:
viewing of errors, validation failures, policy warnings, recommendations, or other information;
fetching and displaying additional information relevant to existing business data or
providing access to additional services, for example generative artificial intelligence (generative-AI) services, to incorporate recommendations or information provided by those services.

10. The method of claim 6, wherein the method is performed within a cloud computing system.

11. A non-transitory computer readable storage medium having instructions thereon, which when read and executed by a computer cause the computer to perform a method comprising:
providing a client device operable to interrogate one or more web services to obtain web service metadata that determines one or more capabilities of those web services;
wherein the metadata is used by an add-component to automatically configure an editable table component in a spreadsheet, wherein the table component is used to retrieve data, edit the data in the spreadsheet, or upload changes back to the web service, or provide validations, recommendations, or other functionalities; and
wherein as the user interacts with the spreadsheet and with particular rows of data or particular cells, the system can automatically communicate with, receive responses, and combine or aggregate related information from one or more web services or other sources of data or information within the spreadsheet interface, and display a row status associated with the data.

12. The non-transitory computer readable storage medium of claim 11, further comprising displaying a row status window that displays information associated with one or more rows of data or cells for user review or action, said information derived from one or more web services;
wherein in response to user interactions to select other rows of data or cells, the system continues to automatically communicate with, receive responses, and combine or aggregate related information from the one or more web services or other sources of data or information, and display an updated row status associated with the other rows of data or cells.

13. The non-transitory computer readable storage medium of claim 11, wherein as the user interacts with the spreadsheet and with particular rows of data or particular cells, the system automatically combines or aggregates related information, in parallel, from a plurality of web services or other sources, within the spreadsheet interface, and displays or updates a row status associated with the data.

14. The non-transitory computer readable storage medium of claim 11, herein the method operates to combine or aggregate related information from multiple endpoints such as web services or other sources, within a spreadsheet interface, for use in performing business tasks, including one or more of:
viewing of errors, validation failures, policy warnings, recommendations, or other information;
fetching and displaying additional information relevant to existing business data or providing access to additional services, for example generative artificial intelligence (generative-AI) services, to incorporate recommendations or information provided by those services.

15. The non-transitory computer readable storage medium of claim 11, wherein the method is performed within a cloud computing system.
